(19) United States
(12) Patent Application Publication
(10) Pub. No.: US 2011/0159247 A1
(43) Pub. Date: Jun. 30, 2011

(54) HEAT RAY SHIELD COVER

(75) Inventors: Akio Sugimoto, Hyogo (JP); Hironobu Nakanishi, Hyogo (JP); Naoki Kikuchi, Hyogo (JP)

(73) Assignee: KABUSHIKI KAISHA KOBE SEIKO SHO (KOBE STEEL, LTD.), Kobe-shi, Hyogo (JP)

(21) Appl. No.: 12/737,975

(22) PCT Filed: Sep. 9, 2009
(86) PCT No.: PCT/JP2009/065759

§ 371 Date: Mar. 4, 2011

(30) Foreign Application Priority Data
Sep. 9, 2008 (JP) 2008-231245

(51) Int. Cl. F02B 77/11; B32B 5/20; B32B 15/08

(52) U.S. Cl. 428/174; 428/319.1; 428/215

(57) ABSTRACT

Provided is a lightweight heat ray shield cover, such as a heat insulator, which has a three-dimensional shape and excellent shielding characteristics. The heat ray shield cover is a cover which is disposed near a heat source (26) such as an engine exhaust pipe and blocks the heat ray from the heat source, the cover being formed of a shaped composite in which aluminum alloy plates (2a, 2b) are layered on both the surfaces of a core foam resin (3b), respectively. The surface of one (2a) of the aluminum alloy plates in the shaped composite is provided to face the heat source (26).

### TECHNICAL FIELD

The present invention relates to a cover such as a heat insulator, which is a protection cover for automobile engine exhaust pipes, for shielding heat rays from heat sources, and in particular to a lightweight heat ray shield cover comprises shaped composite, which is constructed from a resin laminated plate by press forming and foaming the resin. A laminated plate of the present invention comprises aluminum alloy plates laminated on both surfaces of a core foamable resin. The laminated plate is cold-formed (plastically formed) and then the core foamable resin is foamed by heating into a shaped composite. Such a laminated plate or shaped composite is also referred to herein as a “composite plate” as a general term as opposed to a single-piece metal plate.

### BACKGROUND ART

Various types have been used for covers such as heat insulators, which are protection covers for automobile engine exhaust pipes, for shielding heat rays from heat sources. It is well known to use aluminum alloy plates as they are, which are lightweight and have high reflection characteristics for heat rays from heat sources, mirror-surfaced aluminum alloy plates, and steel sheets plated with aluminum, as these types of heat ray shield covers.

A case was disclosed where such an aluminum alloy plate or an aluminum-plated steel sheet was disposed as a heat insulator near automobile engine exhaust pipes, i.e., heat sources, and was connected, for example, to connection pieces on a side end of an elastic gasket (Patent Document 1).

These heat ray shield covers require not only heat shield performance with weight reduction but also heat resistance, sound insulation (sound absorbency) and damping performance (vibration absorbency), depending on heat sources, working environments and uses. On the other hand, heat ray shield covers were proposed with functional materials, which are heat resistant materials, sound insulation materials (sound absorbing materials) or damping materials (vibration absorbing materials) such as glass wool or ceramics, disposed between or on the surfaces of aluminum alloy plates (Patent Documents 2 and 3).

Heat insulators, which are accessories to automobile bodies, are especially required to be lighter in weight in an accelerated trend of weight reduction of the automobile body. If heat ray shield covers such as heat insulators can be made of resin-metal composite plates, much thinner metal plates can be used instead of conventional single-piece metal plates such as aluminum alloy plates or aluminum-plated steel sheets, resulting in weight reduction.

Such resin-metal composite plates have been known, even though they have not been used as heat ray shield covers. For example, for application to automobile body panels requiring damping and sound insulation performance, a relatively thin and lightweight shaped composite (shaped composite panel) has been proposed, which comprises a foam resin as the core material sandwiched between and laminated with two aluminum alloy plates, instead of a single piece metal plate.

Such a shaped composite panel is produced with a foamable resin (resin capable of foaming) as the core material sandwiched between and laminated with two flat aluminum alloy plates with intermediary bonding resins therebetween and by bonding them to integrate into a raw material laminated plate. Then, the raw material laminated plate is formed into a compact with a desired shape with forming process (plasticity forming) such as press or roll forming. Before or after forming, the foamable resin is foamed by heating to the foaming temperature of the foamable resin, which is higher than that of bonding. The foamable resin herein denotes a resin that foams by heating or resin capable of foaming by heating.

With this basic structure, a proposal was disclosed where foam resins with different expansion ratios were laminated by controlling the expansion ratios of the foam resins to improve characteristics of composite plate such as appearance, light weight, shock resistance, heat resistance, heat retaining performance and durability (Patent Document 4). In order to prevent detachment of a foamable resin layer after foaming, a proposal was also disclosed where an adhesive layer and a non-foamable resin layer were placed between the aluminum alloy plate and the foamable resin layer (Patent Document 5).

A proposal was disclosed on a foam resin-laminated sound insulation plate having sound insulation capability and a production method therefor (Patent Document 6). The foam resin-laminated sound insulation plate, which is thinner as a laminated plate as a whole and does not have limitation on shape, installation location and weight, provides good plastic formability such as for press working and sufficient damping performance in the state of use after the heat foaming.

### RELATED ART DOCUMENTS

### [Patent Documents]

Patent Document 1: JP 2006-188975A

Patent Document 2: JP 2001-653663A

Patent Document 3: JP 1995-277811A

Patent Document 4 JP 1998-29258A

Patent Document 5: JP 2006-56121A

Patent Document 6: JP 2004-42649A

### DISCLOSURE OF THE INVENTION

### Problems to be Solved by the Invention

Lighter weight can be achieved compared to single-piece metal plates such as aluminum alloy plates or aluminum-plated steel sheets if above-mentioned foam resin lightweight composite plates as used for automobile body members, sound absorbing members or dampers can be applied to heat ray shield covers such as heat insulators. Such an instance, however, has not been found yet. This is because several large tasks need to be examined and solved before applying resin-metal composite plates to heat ray shield covers. These tasks lie in heat resistance of foam resins used in foam resin lightweight composite plates as well as formability to heat ray shield covers such as heat insulators.

In the case of heat insulators, automobile engine exhaust pipes, i.e., heat sources, are as high as 600 to 800 degrees Celsius in temperature. Accordingly, heat insulators that are disposed near heat sources and shield heat rays therefrom will be exposed to high temperatures by radiant heat or convection heat from the heat sources. The melting temperatures of foamable resins, on the other hand, are at most 200 degrees Celsius, depending on resins. Higher temperatures than 100 degrees Celsius may cause problems such as smoking even though foamable resins may not melt. Generally speaking, foam resin lightweight composite plates cannot be applied to heat ray shield covers such as heat insulators.

Heat ray shield covers such as heat insulators are panels having relatively large areas and thinner thickness for weight reduction. When foam resin lightweight composite plates are used to produce shaped composites for weight reduction instead of above-mentioned single-piece metal plates, it is preferable for manufacturers of automobile body panels to use the same forming press or forming conditions as used when forming single-piece metal plates. For this, raw material laminated plates having thicker plate thicknesses than those of single-piece metal plates cannot be applied and the plate thicknesses of raw material laminated plates are limited to 3.4 mm or less, preferably to 2.4 mm or less. In order to achieve further weight reduction as substitutes of single-piece metal plates, the plate thicknesses of raw material laminated plates cannot be thicker than 3.4 mm.

When the plate thicknesses of raw material laminated plates is reduced as in the case above, the plate thicknesses of the metal plates need to be reduced relatively by increasing the thickness of the foamable resin layer, the density of which is lower compared to that of the metal plates, to secure weight reduction and flexural rigidity. Therefore, the plate thicknesses of individual metal plates constituting raw material laminated plates need to be 1.0 mm or less, even with aluminum alloy plates, which is relatively lightweight. The forming limit of such thinner metal plates will be significantly reduced as they become thinner, which is described later.

The formability of core foamable resins alone, on the other hand, is by no means good. The cold press forming to heat ray shield covers such as heat insulators having above-mentioned relatively large areas is three-dimensional forming. Compared to two-dimensional forming, three-dimensional forming requires significant elongation and modulus of elasticity. Conventional foam resins, however, have been selected focusing on smoothness and appearance, not focusing on cold press formability to three-dimensional shapes. As a result, cold forming of foam resins alone is difficult in terms of formability and shape stability of formed product. Therefore, it is conventionally believed in the resin industry that forming of foam resins alone into panels and the like requires a warm or hot process.

As mentioned above, thinned laminated plates, in which aluminum alloy plates are laminated on both surfaces of a core foamable resin, is a combination of materials having the same tendency where forming is difficult in a single piece and the shape is not stable after forming. Therefore, such thinned laminated plates are generally difficult to be cold-formed into heat ray shield covers such as heat insulators.

Considering these points, the present invention is directed to provide a heat ray shield cover such as a heat insulator comprises the above foam resin lightweight composite plate.

### Means for Solving the Problem

A heat ray shield cover of the present invention for achieving the objective is disposed near a heat source for shielding heat rays from the heat source, the cover comprising: a shaped composite constructed from a laminated plate comprising aluminum alloy plates laminated on both surfaces of a core foamable resin, respectively, the core foamable resin being foamed by heating after forming the laminated plate into a cover shape, wherein the surface of either of the aluminum alloy plates in the shaped composite is arranged to face the heat source.

The shaped composite is preferably formed such that faces of the shaped composite on the periphery of the heat ray shield cover are provided not to face the direction of the heat source to which heat ray shielding is provided. The heat ray shield cover is preferably connected to low temperature parts near the heat source to which heat ray shielding is provided.

The plate thickness of the laminated plate is 3.4 mm or less, the plate thickness of each of the aluminum alloy plates is 0.05 to 1.0 mm, the plate thickness of the core foamable resin is 0.5 to 1.4 mm, and the aluminum alloy plates are selected from type O materials, type H22 to H24 materials, type H32 to H34 materials, and type T4 materials in the material codes specified in JIS H 0001 Standard, and the elongation at the thicknesses in the above ranges is preferably 10% or more. Preferably, the plate thickness of the laminated plate is 2.4 mm or less, the plate thickness of each of the aluminum alloy plates is 0.05 to 0.5 mm, and the plate thickness of the core foamable resin is 0.5 to 1.4 mm. The aluminum alloy plates are preferably selected from 1000 series, 3000 series, 5000 series and 6000 series aluminum alloys.

### Advantage(s) of the Invention

The present inventors found that the heat resistance of composite plate of the present invention is useable for a heat ray shield cover, as shown in the experiment to be mentioned later in which the temperature of the foam resin part of the composite plate did not rise so much even when the temperature of the heat source was high. Specifically, the inventors found that the temperature of the foam resin part in the composite plate (inside the composite plate) disposed near a heat source rose to about 120 degrees Celsius but did not rise further with time, and kept constant, even with the temperature of the heat source as high as 600 degrees Celsius.

The result indicates that the shaped composite with a core foamable resin foamed by heating provides an effect by reflection characteristics to heat rays (radiant heat) from the heat source by one of the aluminum alloy plates disposed toward the heat source. The result also indicate a heat shielding effect on a core foam resin from the heat source through convection with air as a results of lamination of aluminum alloy plates laminated on both surfaces of a core foam resin.

The inventors found that aluminum alloy plates with extremely thin plate thicknesses thereof, which exhibit significantly lowered cold formability as a single piece due to the thickness, can greatly improve their cold formability, against our expectation, when they are combined and laminated with foamable resins, which may otherwise exhibit significantly lowered cold formability as single-plates. The inventors found that shape stability can be improved by lamination even with a single-piece foamable resin, which may otherwise exhibit low shape stability. The inventors found that a composite plate of the present invention can be press-formable in the cold process into heat ray shield covers such as heat insulators with relatively large areas and used as a heat ray shield cover.

The composite plate, according to the present invention, can be applicable to heat ray shield covers such as heat insulators. This enables heat ray shield covers to be lightweight compared to single-piece metal plates of the aluminum alloy plates or aluminum-plated steel sheets.

### BRIEF DESCRIPTION OF THE DRAWINGS

FIG. 1 is a perspective view showing an embodiment of a laminated plate before resin foaming.

FIG. 2 is a perspective view showing an embodiment of a heat ray shield cover of the present invention.

FIG. 3 is a perspective view showing another embodiment of a heat ray shield cover of the present invention.

FIG. 4 is an illustration showing a mode of use of a heat ray shield cover of the present invention.

FIG. 5 shows a partially magnified view of a part in FIG. 4.

FIG. 6 is a graph showing temporal variation of the temperature of the heat ray shield cover as shown in FIG. 2.

### EMBODIMENTS FOR CARRYING OUT THE INVENTION

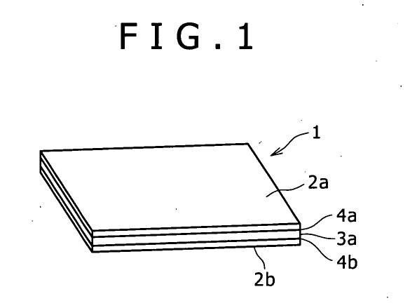

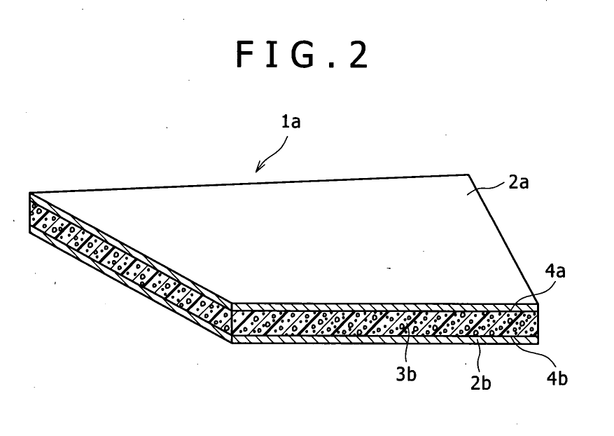

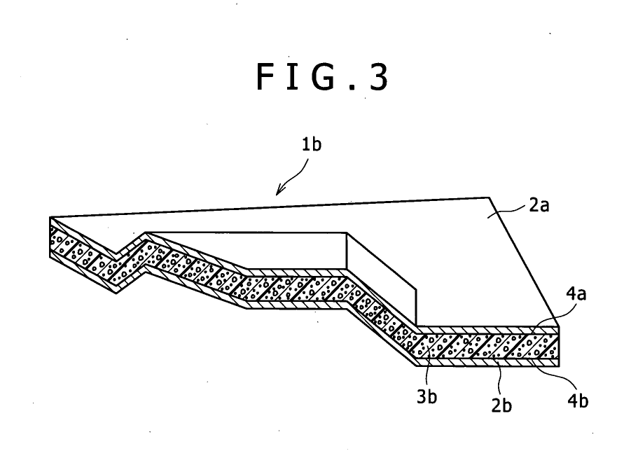

Embodiments of the present invention are described below in reference with attached drawings. FIG. 1 is a perspective view of a laminated plate, which is a raw material of a heat ray shield cover, comprising a laminated core foamable resin before foaming. FIGS. 2 and 3 are partial cross-sectional perspective views showing aspects of shaped composites (shaped composite panels), i.e., heat ray shield covers, with core foam resins (foamed resins) foamed by heating from foamable resins of the core material after forming the laminated plate in FIG. 1.

Raw Material Laminated Plate

As shown in FIG. 1, a laminated plate 1 of the present invention, which is a raw material of heat ray shield covers (shaped composites) in FIGS. 2 and 3, comprises two aluminum alloy plates 2a and 2b sandwiching therebetween a bonding resin film 4a, a foamable resin (unfoamed resin) film 3a, and a bonding resin film 4b, in the order from the top in the figures, in a laminated form.

When the foamable resin 3a itself has a sufficient bonding effect with aluminum alloy plates 2a and 2b, bonding resins 4 may not be necessary. It is preferable, however, to use the bonding resins 4 for securing bonding strength required when forming the laminated plate 1 or for securing bonding strength required as a shaped composite.

Shaped Composite (Heat Ray Shield Cover)

FIG. 2 shows a shaped composite 1a as a heat ray shield cover in a flat shape, and FIG. 3 shows a shaped composite 1b as a heat ray shield cover in a hat-like shape. FIG. 2 shows an aspect of a composite plate 1a with the core material of a foam resin 3b foamed from a foamable resin 3a by heating the laminated plate 1 in a flat plate in FIG. 1. FIG. 3 shows an aspect of a shaped composite (heat ray shield cover) 1b with the core material of a foam resin 3b foamed from a foamable resin 3a by heating the laminated plate 1 in FIG. 1 after cold forming thereof.

Plate Thickness of Laminated Plate

The present invention is directed to a thin laminated plate for a heat ray shield cover, which is cold-formed into a panel shape. Accordingly, the present invention are not directed to thick laminated plates such as for buildings or structures, which cannot be cold-formed into panel shapes. As mentioned above, a raw material laminated plate with the plate thickness of far more than that of a single-piece metal plate cannot be used when producing a shaped composite using a laminated plate of the present invention instead of using a single-piece metal plate to achieve further weight reduction of the heat ray shield cover, due to press forming process and weight reduction. In short, it is preferable for manufacturers of heat ray shield covers to use the same forming press or forming conditions as used when forming single-piece metal plates. It is desirable to achieve further weight reduction of heat ray shield covers as substitutes of single-piece metal plates.

For this reason, a laminated plate of the present invention, for which the thinner the entire plate thickness the better, preferably has the thickness of 3.4 mm or less, more preferably of 2.4 mm or less. The entire plate thickness of a laminated plate is the sum of the plate thicknesses of laminated two aluminum alloy plates 2a and 2b, bonding resin films 4a and 4b, and a foamable resin film 3a. When bonding resin films 4a and 4b are not used, the entire plate thickness of a laminated plate is the sum of the plate thicknesses of two aluminum alloy plates 2a and 2b and a foamable resin film 3a.

Aluminum Alloy Plate

The surface of either of the aluminum alloy plates 2a and 2b in a shaped composite is provided to face a heat source, in other words, to face toward the direction of heat ray (radiant heat) radiation from a heat source, so that heat rays (radiant heat) from the heat source is reflected, as a heat ray shield cover. Aluminum alloy plates 2a and 2b also block convection heat from a heat source by air at the both surfaces of the core foam resin. This allows the temperature of the foam resin part in a heat ray shield cover to be maintained at a relatively low temperature without increasing the temperature thereof, assuring heat resistance as a heat ray shield cover (shaped composite), even in the case of a heat source with a high temperature.

Since such functions and characteristics are possessed by all aluminum alloys regardless of the alloys type, any aluminum alloy can be used as aluminum alloy plates 2a and 2b. Corrosion resistance on the surfaces of aluminum alloys, however, is important for heat ray shield covers, since heat ray shield covers tend to be exposed to high temperature corrosive environment. Corroded surfaces of aluminum alloys will decrease in reflection effects of heat rays (radiant heat) from heat sources, compromising functions, corrosion resistance and heat resistance as heat ray shield covers.

In this regard, among aluminum alloys, 1000 series, 3000 series, 5000 series or 6000 series aluminum alloys are preferably selected to be used as aluminum alloy plates 2a and 2b. Above all, it is preferable to use 1000 series aluminum alloys, pure aluminum series, as defined in Japan Industrial Standards (referred to as “JIS” hereinafter), which exhibits good corrosion resistance. Aluminum alloy plates 2a and 2b may be of the same aluminum alloy or may be different each other in terms of the type of alloys or thermal refining thereof within the range in which characteristics such as formability or rigidity will not be adversely affected.

However, 1000 series aluminum alloy plates have lower strength compared to 3000 series or 5000 series aluminum alloy plates and shape stability after cold forming may decrease when the plate thickness is extremely thin. For this reasons, when using aluminum alloy plates with lower strength such as type O materials of 1000 series aluminum alloy plates, the plate thickness of aluminum alloy plates 2a and 2b of a laminated plate needs to be relatively increased.

Aluminum alloy plates 2a and 2b used are of a tempered material of an aluminum alloy, which is discussed later, preferably a commercially available common cold-rolled sheet in terms of formability. Aluminum alloy plates 2a and 2b are used as a heat ray shield cover without applying coating or surface treatment, in principle, with bare flat and smoothed or mirror surfaces. If necessary, aluminum alloy plates 2a and 2b may be provided with protrusions and dents by embossing, pressing or rolling with appropriate sizes and ranges, entirely across or a part of the surface thereof.

Plate Thickness of Aluminum Alloy Plate

Aluminum alloy plates 2a and 2b to be laminated into such a thin laminated plate, for which the thinner each plate thickness the better, preferably have thicknesses in a range of 0.05 to 1.0 mm, much preferably of 0.05 to 0.5 mm. If even one of the plate thicknesses of the aluminum alloy plates 2a and 2b is less than 0.05 mm, the heat ray shield cover would exhibit significantly low flexural rigidity and strength due to too thin plate thickness in the state of use in which the core foam resin is already foamed. On the other hand, if even one of the plate thicknesses of the aluminum alloy plates 2a and 2b is more than 1.0 mm, strictly 0.5 mm, weight reduction would be sacrificed with heavier weight, losing the meaning itself of producing the heat ray shield cover with shaped composite.

Types of Aluminum Alloy Plates in Terms of Formability

Aluminum alloy plates 2a and 2b laminated in laminated plates require appropriate strength for improved cold formability (forming possibility and shape stability after forming) of the laminated plates. Therefore, aluminum alloy plates 2a and 2b are of tempered materials selected from type O materials, type H22 to H24 materials, type H32 to H34 materials and type T4 materials in the material codes specified in JIS H 0001 Standard. The appropriate strength is also required for flexural rigidity and strength as a heat ray shield cover. The strength of aluminum alloy plates, which certainly depend on alloy composition, is greatly affected by thermal refining. Especially with aluminum alloys such as of 1000 series, 3000 series and 5000 series, tempered materials other than these would not allow laminated plates to be formed into the shapes of heat ray shield covers with sufficiently improved cold formability because the strength is excessively high.

As mentioned above, if the plate thicknesses of aluminum alloy plates constituting a laminated plate are extremely thin, the thinned plates may exhibit extremely reduced elongation compared to a relatively thick plate. Concretely, type O material of 3004 will have about 20% of elongation with a plate thickness of 1.6 mm, but it will significantly be reduced down to 10% or lower, and even about 3%, with a plate thickness of as thin as 0.05 mm (50 μm). This is the same in the case of other aluminum alloys such as of 1000 series, 5000 series or 3000 series.

The present invention uses aluminum alloy plates with extremely lowered elongation as low as 10% or less due to extremely thin plate thickness as aluminum alloy plates 2a and 2b to be laminated into a raw material laminated plate for a heat ray shield cover. Based on the condition, the present invention uses above-mentioned tempered materials as aluminum alloy plates 2a and 2b to secure above-mentioned required strength for the raw material laminated plate.

Functional Effects of Laminated Plate

As mentioned above, when an unfoamed foamable resin 3a and bonding resins 4b are laminated (sandwiched) between two aluminum alloy plates 2a and 2b, improvement effects are provided on cold formability and shape stability after cold forming, compared to a single-piece aluminum alloy plate or single-piece foamable resin, as mentioned above. Lamination of aluminum alloy plates and a foamable resin will allow strain to be uniformly distributed, even when the aluminum alloy plates are thin. This prevents the occurrence of large local elongation or delays the time before the occurrence of large local elongation during cold forming, thereby preventing aluminum alloy thin plates from fracturing in a short time during the cold forming.

Deformation amount δ of a laminated plate 1 by adding a load (forming load) during forming is the sum of elastic deformation amount δE, which will become zero when the load is removed, and plastic deformation amount δP, which will remain the same even when the load is removed. The meaning of “cold-formable to a predetermined shape” is that “a plastic deformation amount δP after an elastic deformation amount δE has become zero is equal to a target deformation amount δ immediately after the forming load is removed.” When a laminated plate 1 is deformed by applying a forming load entirely, the same deformation amount will occur over the aluminum alloy plates 2a and 2b and the foamable resin film 3a because the aluminum alloy plates 2a and 2b and the foamable resin film 3a are integrally laminated. This allows strain to be uniformly distributed, as mentioned above, resulting in improved formability.

The uniform deformation amount and strain distribution brought by such lamination provides an improvement effect on shape stability of the foamable resin at the same time. Because the ratio of elastic deformation (elastic deformation ratio) is generally large with a single-piece foamable resin, even if plastically deformed into a predetermined shape by cold forming, it would exhibit large springback to return to the original linear shape, resulting in low shape stability. With aluminum alloy plates, on the other hand, the ratio of plastic deformation (plastic deformation ratio) is large compared to foamable resins and when plastically deformed into a predetermined shape by cold forming, it would exhibit small springback to return to the original linear shape. Lamination thus improves shape stability by increasing the ratio of plastic deformation (plastic deformation ratio) of the foamable resin. It, therefore, enables heat ray shield covers having relatively large areas to be cold-formed such as press forming to three-dimensional shapes.

When a composite plate is cold-formed into a heat ray shield cover (shaped composite), the foamable resin 3a sandwiched between the two aluminum alloy plates 2a and 2b is restrictively formed. This may prevent the formed shaped composite 1b from warpage, significantly improving the shape precision of the shaped composites 1a and 1b. Furthermore, when foaming a foamable resin 3a, the degree of foaming of the foamable resin 3a between the two aluminum alloy plates 2a and 2b can be controlled by adjusting the space between the aluminum alloy plates 2a and 2b. Therefore, the shape precision of the shaped composites (heat ray shield covers) 1a and 1b with the resin in a foamed state will also be significantly improved.

Furthermore, such lamination provides a structure in which a foamed core foam resin 3b is sandwiched between two aluminum alloy plates 2a and 2b. This provides a lightweight shaped composite with excellent flexural rigidity, even when heat ray shield cover 1a or 1b has a relatively large area.

Thickness of Core Foamable Resin

Based on the assumption of the structure of such a laminated plate, the plate thickness (thickness of unfoamed resin layer) of core foamable resins 3a of the present invention is defined below. When the plate thickness of a laminated plate is 3.4 mm or less, the plate thickness of the core foamable resin should be in a range of 0.5 to 1.4 mm. When the plate thickness of a laminated plate is 2.4 mm or less, the plate thickness of the core foamable resin should be in a range of 0.5 to 1.4 mm. If the thickness of an unfoamed resin layer varies by location of the laminated plate, an average value at selected appropriate locations on the laminated plate is applied.

When the plate thickness of a core foamable resin 3a is too thin, it decreases an improvement effect on formability of the core foamable resin 3a as a laminated plate during cold forming, which uniformly distributes strain in the aluminum alloy thin plate with elongation as extremely low as 10% or less. In such a case, it exhibits no large differences from a single-piece aluminum alloy plate, in which a large local elongation may be generated in a short time in cold forming, causing the fracture of the aluminum alloy thin plate in a short time during cold forming, compromising formability significantly. When the plate thickness of a core foamable resin 3a is too thin, thickness of the core foam resin 3b will becomes thin, without achieving weight reduction compared to a single-piece aluminum alloy plate with the same flexural rigidity or strength, losing the meaning of using a shaped composite for a heat ray shield cover.

When, on the other hand, the plate thickness of a core foamable resin 3a is too thick, the aluminum alloy plate will become relatively thin (as a laminated plate), compromising the effects thereof, which would not much different from those of a single-piece foamable resin. Thus, foamable resin with a large ratio of elastic deformation (elastic deformation ratio), even if plastically deformed into a predetermined shape by cold forming, would exhibit large springback to return to the original linear shape, resulting in low shape stability. If the plate thickness of a core foamable resin 3a is too thick, the heat ray shield cover having a relatively large area would exhibit significantly low flexural rigidity and strength in the state of use.

Expansion Ratio of Core Foamable Resin

The expansion ratio from a core foamable resin 3a to a core foam resin 3b (after foamed) is preferably about two to twenty times. This assures both weight reduction and flexural rigidity and strength of heat ray shield covers having relatively large areas. When the expansion ratio is too small, the shaped composite would not be lightweight compared to a single-piece aluminum alloy plate with the same flexural rigidity or strength, probably losing the meaning of using a shaped composite for a heat ray shield cover. If the expansion ratio is too high, the heat ray shield cover would probably exhibit significantly lowered flexural rigidity and strength in a state of use.

Types of Core Foamable Resins

The core foamable resin 3a of a laminated plate preferably includes, as a polyolefin group resin(s), one or more of random copolymer polypropylene group resins (R.PP), homo polypropylene group resins (H.PP), and copolymer polypropylene group resins (B.PP) with a melting flow rate (MFR g/10 min) in a range of 0.1 to 50 g/10 min. These polypropylene group resins have the large improvement effect on formability that allows strain in aluminum alloy thin plates with lowered elongation to be uniformly distributed compared to other resins. In other words, a large improvement effects can be obtained on formability such as forming possibility and shape stability when the core foamable resin 3a is combined and laminated with aluminum alloy thin plates of tempered materials such as type O materials, type H22 to H24 materials, type H32 to H34 materials and type T4 materials.

The core foamable resin 3a of a laminated plate is made from a resin(s) as mentioned above by adding and mixing with commercially available heat-decomposing foaming agents to give foamability. In this case, polypropylene group resins as mentioned above may be used alone individually or used as a polymer blend in which resins of these are added and mixed.

Application Example of Resins

For application examples of resins, various resins having different characteristics may be blended, or inorganic or metallic fillers, or additives may be added so that the shaped composite may be highly functional or multifunctional in the characteristics. For example, the use of foamable resin, bonding resin, or resins with high damping performance or high sound absorbency may increase damping, sound insulation, or sound absorbing performance. The use of a conducting substance may increase welding performance. When the above-mentioned foamable resin 3a or bonding resin 4 is added with metallic powder as a conductive substance, the resin may be of high density, increasing sound insulation performance as well as welding performance.

Polyolefin group resins that may be used for the foamable resin 3a may have melting points of 140 to 160 degrees Celsius and thermal decomposition temperatures of about 400 degrees Celsius. In order to uniformly diffuse a thermal decomposition foaming agent added to resin, the foaming agent needs to be mixed at a temperature of 20 to 30 degrees Celsius higher than the melting point. Furthermore, to prevent the start of foaming of the foaming agent during mixing, the foaming temperature should be higher than the mixing temperature by 10 degrees Celsius or more and sufficiently lower than the thermal decomposition temperature, preferably set at 170 to 300 degrees Celsius. Thus, heating the foamable resin 3a to 170 to 300 degrees Celsius enables uniform foaming without causing deterioration of the foamable resin 3a.

(Bonding Resin)

Bonding resins 4a and 4b comprises resin that can bond (with a bonding strength) a foamable resin 3a to aluminum alloy plates 2a and 2b. For core foamable resins made from polyolefin group resins as mentioned above as the main component, preferably used as bonding resins 4a and 4b are thermal fusion bonding thermoplastic resins comprising polyolefin as the main component denatured, for example, by maleic anhydride.

(Configuration of Resins)

These foamable resins and bonding resins should not be limited to those in the form of a film or sheet. Either one (the other may be in the form of a film or sheet) or both of a foamable resin and a bonding resin may be applied, in melted state or dissolved state in a solvent, using a roller or by spray. This application is preferably followed by drying process.

Furthermore, the foamable resin 3a may be added with a lubricant to improve formability, so as to reduce contact friction with a mold in press forming and prevent fracture of the resin. Alternatively, similar effects can be obtained by affixing lubrication-dedicated film on the surface of the foamable resin 3a or by coating for lubrication.

Production Methods of Heat Ray Shield Cover (Shaped Composite)

A production method of heat ray shield covers (shaped composite) is now described below.

Foamable Resins

Firstly, resin materials constituting a foamable resin 3a are mixed. The stuff contains resins and a thermal decomposition foaming agent, and if necessary, added with substances to provide bonding strength, damping performance or heat resistance or with metal powder to improve conductivity. The stuff is well mixed and formed into a film or sheet. When formed into film, the stuff is rolled into a coil. The mixing temperature of the stuff is preferably set at a temperature lower than the thermal decomposition temperature of the used foaming agent by 10 degrees Celsius or more. This will prevent the occurrence of foaming, even when the temperature of the resin rises due to mixing.

Bonding Resins

Firstly, resin materials constituting a bonding resin 4 are mixed. The stuff is added, if necessary, with substances to provide bonding strength or damping performance or with metal powder to improve conductivity. These materials are well mixed and formed into a film or sheet. When formed into film, the stuff is rolled into a coil to be laminated separately or applied onto the surfaces of aluminum alloy plates.

The foamable resin film or sheet and the bonding resin may be thermally fused together before rolled into a coil. Alternatively, the foamable resin and the bonding resin may be integrated together such that the surfaces of the foamable resin are covered with the bonding resin with two-type/three-layer extrusion when the foamable resin sheet or film is extruded from a die. When the foamable resin film and the bonding resin film are already coiled separately, a bonding resin film 4 and a foamable resin film 3a may be simultaneously laminated on an aluminum alloy plate 2 by extending the individual films from the two coils. In either case, the foamable resin 3a, which is in an unfoamed state and thin in thickness, can be rolled into a coil. This allows transportation in a coiled state and extension from the coil at a working site, requiring no limitation on the working site.

Production of Laminated Plates

The most easiest way to construct a laminated plate is to laminate one by one aluminum alloy plates 2a and 2b in the form of cut plates, a bonding resin film 4 and a foamable resin film 3a in the form of cut plates. When facilities allow, continuous lamination may be applied to construct laminated plates. In other words, the foamable resin film and the bonding resin film may be simultaneously laminated between aluminum alloy plates 2a and 2b by extending the aluminum alloy plates 2a and 2b from coils while extending and expanding each of the foamable resin film and bonding resin film from coils. After lamination of these, the aluminum alloy plates 2 and the foamable resin 3a in FIG. 1 can be bonded together with bonding resins placed therebetween by squeezing and heating, for example, by a hot roller, to produce a raw material laminated plate 1. The temperature of the hot roller is set, below the foaming temperature of the foamable resin 3a, roughly near the melting points of the foamable resin and the bonding resin. This enables foamable resins comprising polyolefin, which inherently has no adhesiveness, and hydroxide film generated on the surface of the aluminum alloy plate to be bonded with denatured polyolefin. As a result, the bonding strength between the aluminum alloy plate and the foamable resin required for cold forming can be secured.

(Forming)

The produced laminated plates 1 is cold-formed so as to have a predetermined shape of a shaped composite (panel) 1a or 1b. For forming methods, press forming and bending may be applied including bulge forming, draw forming and bending forming.

(Heating and Foaming)

The shaped composite formed into a predetermined shape in such a forming method is heated to the foaming temperature to allow the foamable resin 3a to foam into a foam resin 3b, providing a shaped composite 1a or 1b. Heating may be applied after cold forming using a convection-heating furnace such as batch or continuous gas or electric furnace. Although aluminum alloys have high heat ray reflectance, aluminum alloy plates 2a and 2b, which could not be used as they are, in a far infrared furnace, can be heated in a far infrared furnace by providing heat ray absorbing layer such as coating or organic film on the outer surface of at least one thereof. Furthermore, if hot press is used that is capable of heating and/or cooling, foamable resins 3a can be cold press-formed and foamed into foam resins 3b by heat foaming without transfer, and the heat-softened foam resins 3b can be cooled and hardened. This allows production of foamed and highly rigid shaped composites from flat composite plates quickly. In addition, shaped composites immediately after heat foaming, which are soft and would require cooling time to retain the shapes after forming, can be cooled in and removed in a short time from the same mold as used in forming without the need of transfer so that the shapes would not change, resulting in higher productivity.

When the foamable resin 3a of a laminated plate 1 is foamed first and then formed, the above-mentioned lamination effects of the aluminum alloy plates 2a and 2b and the foamable resin film 3a may be reduced by half. In other words, because the effect of the foam resin 3b after foaming that uniformly distributes strain in the aluminum alloy thin plate with elongation as extremely low as 10% or less is significantly low compared to an unfoamed core foamable resin 3a, cold formability of the laminated plate 1 is significantly reduced.

Mode of Use of Heat Ray Shield Cover

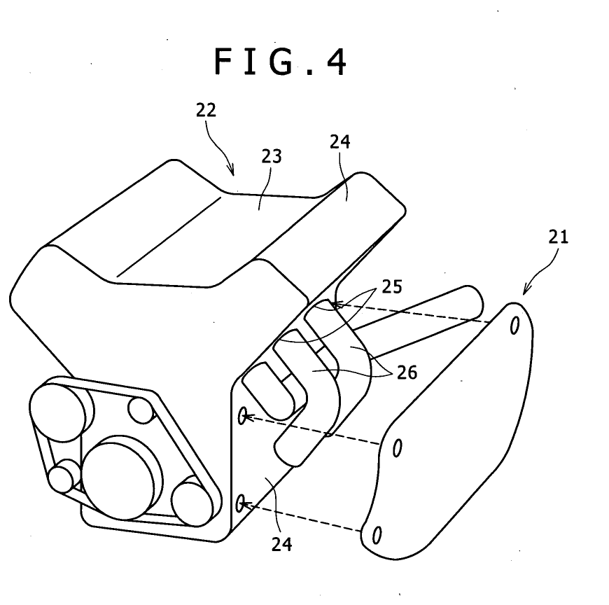

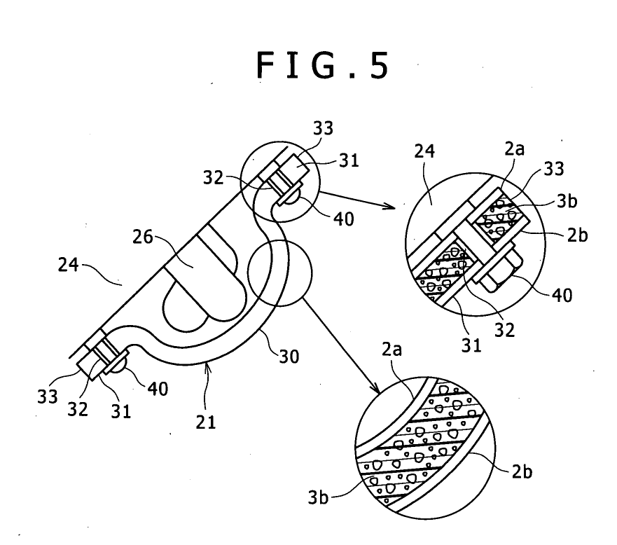

Modes of use of these produced heat ray shield covers, i.e., modes as the heat ray shielding method, are discussed below in reference to FIGS. 4 and 5. FIG. 4 is an exploded perspective view of a heat insulator (heat prevention device) 21 of an automobile engine 22 and FIG. 5 is a partially magnified view of the heat insulator 21 in FIG. 4.

In FIG. 4, the automobile engine 22 is configured by a cylinderhead 23 and a cylinder block 24, both of which are connected each other via an intermediating cylinderhead gasket (not shown). The cylinderhead 23 of the automobile engine 22 is provided with exhaust port holes 25 where combustion exhaust gas exhausts therethrough. The exhaust port holes 25 are connected to plural exhaust pipes (exhaust manifold) 26 via exhaust manifold gaskets (not shown). The cylinderhead 23 is provided with a cylinderhead cover 24 such as of synthetic resin via, e.g., a rubber seal.

In such an automobile engine segment, a high temperature heat source that requires a heat ray shield is only the exhaust pipes 26, which is as hot as 600 to 800 degrees Celsius. Other than these, the cylinderhead 23, the cylinder block 24 and the cylinderhead cover 24 are low temperature heat sources, as low as 80 to 100 degrees Celsius, requiring no heat ray shielding. As shown in FIG. 5, the heat insulator 21, i.e., heat ray shield cover, has a hat-like shape 1b as in FIG. 3 so as to cover the exhaust pipes 26, i.e., high temperature heat source.

The heat insulator 21 is connected to low temperature parts (low temperature heat sources) such as the cylinderhead 23, the cylinder block 24 and the cylinderhead cover 24 close to the exhaust pipes 26, i.e., heat sources. For example, in FIG. 5, heat insulator 21 is connected to the cylinderhead cover 24, i.e., a low temperature heat source. In other words, the heat insulator 21 is provided with plural through-holes 32 at appropriate intervals along the circumferential direction on the flange part 31 spreading horizontally around the top 30 of the hat-like shape. The flange part 31 and the cylinderhead cover 24 are connected through these through-holes 32 with mechanical connection means 40 such as bolts and nuts. In such a manner, in which the heat insulator 21 is connected to low temperature parts near the heat source, the heat insulator 21 requires the minimum area thereof, providing good formability of the laminated plate 1 and easy connection itself.

A partially magnified view of the top 30 of the hat-lie shape of the heat insulator 21 is shown in the circle in the right in FIG. 5. As shown in the magnified view, the side of the aluminum alloy plate 2a constituting the heat insulator 21 (either side of the aluminum alloy plates 2a and 2b of the heat insulator 21) is disposed with the surface facing toward exhaust pipes 26, i.e., heat sources. Thus, the aluminum alloy plate 2a is disposed toward the direction of heat ray (radiant heat) radiation from the exhaust pipes 26, i.e., heat sources, to reflect heat rays (radiant heat) from the exhaust pipes 26.

On the other hand, the aluminum alloy plate 2b as well as the aluminum alloy plate 2a are laminated over and cover both sides of the core foam resin 3b to protect and shield the core foam resin 3b from convection heat from the exhaust pipes 26 by air. This allows the temperature of the foam resin part in a heat ray shield cover to be maintained at a relatively low temperature of about 120 to 140 degrees Celsius without increasing the temperature thereof by shielding heat rays, assuring heat resistance as a heat ray shield cover (shaped composite), even in the case of exhaust pipes 26, i.e., a heat source, the temperature of which is as high as 600 to 800 degrees Celsius.

A partially magnified view of the periphery of the flange part 31 of the heat insulator 21 is shown in the circle in the upper right in FIG. 5. As shown in the magnified view, faces 33 of the shaped composite on the periphery of the flange part 31 do not face exhaust pipes 26 to which the heat ray shielding is provided. In other words, the heat insulator 21 is formed not to face the faces 33 of the shaped composite (core foam resin 3b) at the periphery of the heat insulator 21 toward exhaust pipes 26 so that the faces are not exposed to heat rays from the exhaust pipes 26 to secure heat resistance.

### EXAMPLES

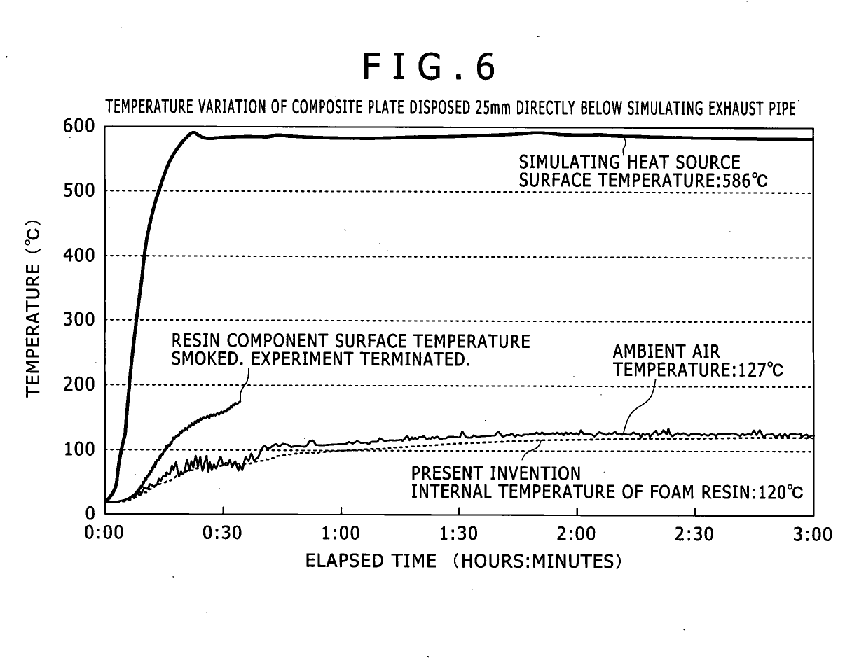

A heat ray shield cover in a flat shape as shown in FIG. 2 (composite plate la with a core foam resin 3b from a core foamable resin 3a) was produced. This was placed upright with the surface of the aluminum alloy plate 2a facing toward a heat source heater, a heat source simulating heater at 600 degrees Celsius, with the distance of 25 mm in the horizontal direction, and the temperature was measured at the core foam resin 3b inside the composite plate 1a that constitutes a heat ray shield cover. FIG. 6 shows temporal transition of the temperature. In this experiment as well, the heat ray shield cover in a flat shape was designed for its size and distance and disposed so that the faces of the shaped composite (core foam resin 3b) on the periphery thereof was not exposed to heat rays from the heat source simulating heater (was formed so as not to face the faces toward the heat source simulating heater) to secure heat resistance.

As a reference, a single-piece core foam resin 3b was placed upright in the same condition as with the heat ray shield cover and the temperature of the core foam resin 3b was measured, which is also shown in FIG. 6. FIG. 6 also shows the surface temperature of the heat source simulating heater and ambient air temperature of the composite plate 1a of the heat ray shield cover.

Production Conditions of Composite Plate 1a

1. The laminated plate 1 was produced in a plane square shape with the dimensions of 600 mm in length (L direction) and 1100 mm in width (LT direction). The total plate thickness of laminated plate 1 was 1.1 mm.

2. Type O material of a single-piece aluminum alloy plate of a JIS 3004 of a plate thickness of 0.05 mm (50 μm) was used for the aluminum alloy plates 2a and 2b that constitute the laminated plate 1. The total plate thickness of the aluminum alloy plates 2a and 2b was 0.1 mm.

3. A sheet of the average plate thickness of 0.9 mm was used commonly for each example as the core foamable resin 3a, which was produced from a random copolymer polypropylene group resin with the melting point of 140 degrees Celsius as the base resin by mixing with a foaming agent of a thermal decomposition temperature of 170 to 180 degrees Celsius and by extruding into a sheet.

4. A polyolefin group hotmelt bonding resin film of a thickness of 0.05 mm with a melting point of 140 degrees Celsius was used for the bonding resins 4a and 4b for each example commonly. The total plate thickness of the bonding resin films was 0.1 mm.

5. As for the foaming condition of the core foamable resin 3a, the laminated plate 1 was heated to 175 degrees Celsius for six minutes and then left for cooling.

6. The single-piece core foam resin 3b as a reference was produced with the same condition except aluminum alloy plates 2a and 2b were excluded from the laminated plate 1 or the composite plate 1a.

As shown in FIG. 6, the example of the present invention (represented by the lowermost thin line marked with “Present invention”), which shows the lowest temperature, keeps the temperature of the foam resin 3b in the composite plate 1a of the heat ray shield cover constant around 120 degrees Celsius, even with the surface temperature of the simulating heat source as high as 600 degrees Celsius. In other words, the temperature of the foam resin 3b in the composite plate 1a of the heat ray shield cover of the present invention rose to about 120 degrees Celsius, but did not rise further with time, staying around 120 degrees Celsius. The ambient air temperature of the composite plate 1a was about the same as the temperature of the foam resin 3b part, showing the similar time course.

In contrast to this, the reference single-piece core foam resin 3b (which is represented by the line marked “Resin component surface temperature” between the line of the present invention and that of simulating heat source and which is terminated after the elapsed time of 0:30) generated smoke as show in FIG. 6 when it came close to 200 degrees Celsius and the experiment was terminated.

These results prove that the foam resin lightweight composite plate of the present invention provides a reflection effect to heat rays (radiant heat) from a heat source with the aluminum alloy plate disposed toward a heat source and a convection heat shielding effect by the aluminum alloy plates laminated on both surfaces of the core foamable resin. Thus, the foam resin lightweight composite plate of the present invention can be used as a heat ray shield cover 1a.

It was also proved that aluminum alloy plates with extremely thin plate thicknesses, which would exhibit significantly low cold formability as single pieces, can greatly improve their cold formability (forming possibility and shape stability) to a heat ray shield cover, when they are combined and laminated with a foamable resin, which may also exhibit significantly low cold formability as a single piece. The laminated plates 1 thus proved itself to be cold-press-formable to a heat ray shield cover such as a heat insulator having a relatively large area. This fact also indicates that the shaped composite 1a of the present invention can be used as a heat ray shield cover.

It is proved that heat ray shield covers can be reduced in weight compared to single-piece metal plates such as aluminum alloy plates or aluminum-plated steel sheets because the foam resin lightweight composite plate according to the present invention can be applied to heat ray shield covers such as heat insulators.

### INDUSTRIAL APPLICABILITY

As mentioned above, the present invention can be applied to lightweight heat ray shield covers such as heat insulators with three-dimensional shapes with excellent heat ray shielding performance. The present invention can be applied as a heat ray shielding method, which comprises forming a laminated plate with a core foamable resin laminated with aluminum alloy plates on both side thereof into a shape for a heat ray shield cover, heating the core foamable resin to be foamed to obtain a shaped composite that constitutes the heat ray shield cover, and disposing the heat ray shield cover near a heat source with the surface of either one of the aluminum alloy plates therein facing toward the heat source.

The present invention has been described in detail with reference to particular embodiments, but it will be apparent that various variation and modification can be applied to them without deviating the spirit and the scope of the present invention by those skilled in the art. The present application is based on Japanese patent application (application number 2008-231245) filed on Sep. 9, 2008, which is hereby incorporated by reference herein in its entirety.

### DESCRIPTION OF SYMBOLS

1: laminated plate, 1a: shaped composite (or composite plate), 1b: shaped composite (or composite plate), 2: aluminum alloy plate, 3a: (core) foamable resin (film), 3b: (core) foam resin, 4: bonding resin (film), 21: heat insulator, 26: exhaust pipes of a heat source, 30: heat insulator top, 31: heat insulator flange part, 32: through-hole, 33: heat insulator periphery surface

1. A heat ray shield cover disposed near a heat source for shielding heat rays from the heat source, the cover comprising:
a shaped composite constructed from a laminated plate comprising aluminum alloy plates laminated on both surfaces of a core foamable resin, respectively, said core foamable resin being foamed by heating after forming said laminated plate into a cover shape,
wherein the surface of either of said aluminum alloy plates in said shaped composite is arranged to face the heat source.

2. The heat ray shield cover according to claim 1, wherein said shaped composite is formed such that faces of said shaped composite on the periphery of the heat ray shield cover are provided not to face the direction of the heat source to which heat ray shielding is provided.

3. The heat ray shield cover according to claim 1, wherein the heat ray shield cover is connected to low temperature parts near the heat source to which heat ray shielding is provided.

4. The heat ray shield cover according to claim 1, wherein the plate thickness of said laminated plate is 3.4 mm or less,
the plate thickness of each of said aluminum alloy plates is 0.05 to 1.0 mm, the plate thickness of said core foamable resin is 0.5 to 1.4 mm, and
said aluminum alloy plates are of a tempered material selected from type O materials, type H22 to H24 materials, type H32 to H34 materials, and type T4 materials in the material codes specified in JIS H 0001 Standard.

5. The heat ray shield cover according to claim 4, wherein the plate thickness of said laminated plate is 2.4 mm or less,
the plate thickness of each of said aluminum alloy plates is 0.05 to 0.5 mm, and the plate thickness of said core foamable resin is 0.5 to 1.4 mm.

6. The heat ray shield cover according to claim 4, wherein said aluminum alloy plates are selected from 1000 series, 3000 series, 5000 series and 6000 series aluminum alloys.

7. The heat ray shield cover according to claim 2, wherein the heat ray shield cover is connected to low temperature parts near the heat source to which heat ray shielding is provided.
